(19) United States
(12) Patent Application Publication
(10) Pub. No.: US 2024/0184941 A1
(43) Pub. Date: Jun. 6, 2024

(54) METHOD FOR INTEGRATED DESIGN OF COMPRESSOR BLADE AND CASING TREATMENT

(71) Applicant: INSTITUTE OF ENGINEERING THERMOPHYSICS, CHINESE ACADEMY OF SCIENCES, Beijing (CN)

(72) Inventors: Juan Du, Beijing (CN); Zhonggang Fan, Beijing (CN); Dun Ba, Beijing (CN); Min Zhang, Beijing (CN); Chen Yang, Beijing (CN); Xiaobin Xu, Beijing (CN)

(21) Appl. No.: 18/494,619

(22) Filed: Oct. 25, 2023

(30) Foreign Application Priority Data
Oct. 25, 2022 (CN) 202211306782.2

(51) Int. Cl. G06F 30/17; G06F 30/28

(52) U.S. Cl. CPC G06F 30/17; G06F 30/28; G06F 2113/08

(57) ABSTRACT

A method for integrated design of compressor blade and casing treatment is applied in the field of turbomachinery. The method includes: determining a parameterization method for blade and casing treatment based on a compressor blade model and a casing treatment model, respectively; obtaining an initial parameter set by using a sampling technology; and obtaining a design with a wide stability margin by using an advanced optimization algorithm without reducing a compressor efficiency. The method may couple an interaction between blades and casing treatment, greatly improving fitness of the casing treatment, so that the compressor may operate stably over a wide working range and R&D costs may be saved.

### CROSS-REFERENCE TO RELATED APPLICATION(S)

This application claims priority to Chinese Patent Application No. 202211306782.2, filed on Oct. 25, 2022, the disclosure of which is hereby incorporated in its entirety by reference.

### TECHNICAL FIELD

The present disclosure relates to the field of turbomachinery, and more specifically, to a method for integrated design of compressor blade and casing treatment.

### BACKGROUND

In recent years, aero-engines have been developing rapidly toward high thrust-to-weight ratio and low fuel consumption. As the blade loading of the compressor continues to increase, an internal flow of the compressor has become more complex, posing higher demands for aerodynamic stability of the compressor. When a working state of the compressor approaches a surge boundary from a design point, there are mainly two typical flow instability phenomena, namely rotating stall and surge. In terms of rotating stall, there are two widely recognized forms of stall precursors in the industry: large-scale mode-type stall precursors and small-scale spike-type stall precursors, and instability characteristics of modern highly loaded compressors are mainly characterized by spike-type stall precursors. For the flow stability problem, technologies of enhancing the stability of compressors mainly include two methods: active control and passive control. Compared with the active control method, which is still in the laboratory research stage, the passive control method has been studied earlier and has been applied to various engines. An intermediate stage bleed method for multi-stage axial flow compressor, inlet guide vane adjustment, and splitter design have all been used in a stability control of compressors, meanwhile, they also increase a complexity of the mechanism to varying degrees. Casing treatment, discovered by chance in the 1960s, has become one of the most widely used stability enhancement technologies in the field of turbomachinery due to its advantages of simple configuration, low cost, and strong resistance to distortion. At present, axial slots and circumferential grooves are the most widely studied.

In order to improve the stability of the compressor, related technical personnel have proposed various stability enhancement configurations for axial slots and circumferential grooves. However, due to limitations of measurement methods and understanding of the stability enhancement mechanism, it is difficult to formulate a universal design criterion for the casing treatment, and a design method for coupling blade to the casing treatment has not yet been found to improve a stability margin of the compressor.

### SUMMARY

In view of this, embodiments of the present disclosure provide a method for integrated design of compressor blade and casing treatment, which including: determining a parameterization method for compressor blade and casing treatment and determining a parameter set based on compressor blade model and casing treatment model; obtaining an initial population N, by using a sampling method, where i=1, 2, . . . , N, and N represents a number of the initial population; obtaining a pressure rise coefficient-mass flow coefficient characteristic curve and a efficiency-mass flow coefficient characteristic curve under a whole working condition by performing a Reynolds-Averaged Navier-Stokes (RANS) numerical simulation on a smooth-casing compressor, and determining a mass flow m_{NS} of the smooth-casing compressor under a near stall working condition and a mass flow m_{PE} of the smooth-casing compressor under a peak efficiency working condition; for the initial population of integrated design of compressor blade and casing treatment, extracting a bell-shaped distribution curve of axial momentum in a rotor tip region and a compressor outlet efficiency, respectively, by preforming two RANS numerical simulations with a given boundary condition of the mass flow m_{NS} under the near stall working condition and a given boundary condition of the mass flow m_{PE} under the peak efficiency working condition, so as to obtain fitness of the initial population, wherein the fitness of the initial population includes a stall margin indicator M, and an efficiency Pᵢ; constructing a surrogate model based on the initial population, using a multi-objective optimization algorithm to obtain a pareto front, and determining a design with a maximum stall margin indicator without reduction of the efficiency.

According to embodiments of the present disclosure, the parameterization method is a free-form deformation technology, and the parameter set is obtained based on a deformation constraint condition; the parameter set comprises a rotor tip region parameter set and a casing treatment parameter set, wherein the rotor tip region parameter set comprises a blade leading edge bend, a blade trailing edge bend, a blade leading edge sweep, a blade trailing edge sweep, and a blade rotation, and the casing treatment parameter set comprises an axial slot bend, an axial slot sweep, an axial slot rotation, an axial slot height, and a circumferential groove scaling.

According to embodiments of the present disclosure, the deformation constraint condition comprises that: a variation range of a control point for the blade leading edge bend is −10% to 25% of an axial blade tip chord length, a variation range of a control point for the blade trailing edge bend is −10% to 25% of the axial blade tip chord length, a variation range of a control point for the blade leading edge sweep is −10% to 25% of the axial blade tip chord length, a variation range of a control point for the blade trailing edge sweep is −10% to 25% of the axial blade tip chord length, a variation range of a control point for the blade rotation is −60° to 60°, a variation range of a control point for the axial slot bend is −15% to 15% of the axial blade tip chord length, a variation range of a control point for the axial slot sweep is −15% to 15% of the axial blade tip chord length, a variation range of a control point for the axial slot rotation is −60° to 60°, a variation range of a control point for the axial slot height is −5% to 20% of the axial blade tip chord length, and a variation range of a control point for the circumferential slot scaling is 4.4% to 17.8% of the axial blade tip chord length.

According to embodiments of the present disclosure, the sampling method is a Latin hypercube sampling method, and the initial population N, is obtained, where i=1, 2, . . . , N.

According to embodiments of the present disclosure, the RANS numerical simulation comprises: processing the compressor blade and casing treatment by using a grid partitioning technology, wherein a grid near a wall is encrypted to obtain a full three-dimensional computational grid; and calculating and solving a three-dimensional Reynolds averaged Navier-Stokes equation by using a turbulence model, so as obtain the pressure rise coefficient-mass flow coefficient characteristic curve and the efficiency-mass flow coefficient characteristic curve under the whole working condition.

According to embodiments of the present disclosure, the near stall working condition is located at a leftmost end of the pressure rise coefficient-mass flow coefficient characteristic curve, and the peak efficiency working condition is located at a top end of the efficiency-mass flow coefficient characteristic curve.

According to embodiments of the present disclosure, an extraction of the stall margin indicator Mᵢ comprises: dividing a rotor tip region into discrete control volumes based on a discrete condition, wherein the discrete condition comprises that: the control volume extends 20% of a blade height from an inner wall of the casing toward a hub in a radial direction, and the control volume covers a leading edge and a trailing edge in an axial direction to cover a region affected by a tip leakage flow; calculating axial momentum of each discrete control volume, respectively, and accumulating the axial momentum along the axial direction so as to obtain the bell-shaped distribution curve of axial momentum, and a position corresponding to a maximum accumulated axial momentum in the axial direction is the stall margin indicator Mᵢ.

According to embodiments of the present disclosure, the efficiency Pᵢ is an efficiency corresponding to the peak efficiency working condition.

According to embodiments of the present disclosure, wherein the surrogate model is a Kriging surrogate model, and the multi-objective optimization algorithm is an NSGA-II optimization algorithm, including fast non-dominated sorting configured to globally search for a non-inferior solution set and a density estimation function configured to analyze a density of the design solution in a design space; and a fitness function is predicted by the Kriging surrogate model.

### BRIEF DESCRIPTION OF DRAWINGS

The above and other objectives, features, and advantages of the present disclosure will be more apparent through the following descriptions of embodiments of the present disclosure with reference to the accompanying drawings, in which:

FIG. 1 shows a flowchart of a method for integrated design of compressor blade and casing treatment according to an embodiment of the present disclosure;

FIG. 2 shows a schematic structural diagram of a compressor blade and casing treatment in a meridian direction according to an embodiment of the present disclosure;

FIG. 3 shows a schematic diagram of a rotor tip region control volume according to an embodiment of the present disclosure;

FIG. 4 shows a schematic diagram of an axial slot control volume according to an embodiment of the present disclosure;

FIG. 5 shows a schematic diagram of a discrete control volume in a meridian direction according to an embodiment of the present disclosure; and

FIG. 6 shows a three-dimensional schematic diagram of a discrete control volume according to an embodiment of the present disclosure.

### DETAILED DESCRIPTION

Embodiments of the present disclosure will be described below with reference to the accompanying drawings. It should be understood that these descriptions are exemplary only and are not intended to limit the scope of the present disclosure. In the following detailed description, for convenience of explanation, numerous specific details are set forth to provide a comprehensive understanding of embodiments of the present disclosure. Obviously, one or more embodiments may be implemented without these specific details. In addition, descriptions of well-known structures and techniques are omitted below to avoid unnecessarily confusing the concept of the present disclosure.

The terms used herein are for describing specific embodiments only and are not intended to limit the present disclosure. The terms “including”, “comprising” and the like, as used here indicate a presence of stated features, steps, operations, and/or components, but do not exclude a presence or addition of one or more other features, steps, operations, or components.

All terms (including technical and scientific terms) used here have the same meaning as commonly understood by those ordinary skilled in the art, unless otherwise defined. It should be noted that the terms used here should be interpreted to have meanings consistent with the context of the present disclosure, and should not be interpreted in an idealized or overly rigid manner.

When an expression similar to “at least one of A, B, C, etc.” is used, it should generally be interpreted in accordance with the meaning generally understood by those skilled in the art (For example, “a system having at least one of A, B, or C” shall include, but is not limited to, a system having A alone, B alone, C alone, A and B, A and C, B and C, and/or A, B and C).

For the aerodynamic instability problem of compressors, technology of enhancing the stability of compressors mainly includes two methods: active control and passive control. Compared with the active control, which is still in the laboratory research stage, the passive control method has been studied earlier and has been applied to various engines.

The intermediate stage bleed method for multi-stage axial flow compressor, inlet guide vane adjustment, and splitter design have all been used in the stability control of compressors, meanwhile, they also increase the complexity of the mechanism to varying degrees. The later discovered casing treatment has become one of the most widely used stability enhancement technologies in the field of turbomachinery due to its advantages of simple configuration, low cost, and strong resistance to distortion. At present, axial slots and circumferential grooves are the most widely studied.

Related art founds that the axial slot has the most prominent stability enhancement effectiveness but also the greatest negative impact on efficiency. The circumferential groove has a stability enhancement effectiveness not as obvious as that of the axial slot, but its negative impact on efficiency is smaller. For the two types of casing treatment configurations, researchers have conducted a large number of parameterized experimental studies on profile, axial position, open area ratio of the axial slot and axial position of the groove, and have achieved significant results. The experimental results show that the axial slot casing treatment may achieve a margin improvement of about 20%, but a loss of peak efficiency also reaches 10%, while the circumferential groove may achieve a stable margin expansion of 10% without reducing or slightly reducing the peak efficiency.

Researchers have carried out a large number of numerical calculations and experimental studies on stability enhancement solution of axial slot casing treatment, circumferential groove casing treatment, and slot-groove hybrid casing treatment. However, due to the limitations of measurement methods and understanding of the stability enhancement mechanism, it is difficult to formulate a universal design criterion for casing treatment. At present, a casing treatment designed for coupling with blades has not been found, and a method for integrated design of blade and casing treatment is still in a blank stage.

In view of this, embodiments of the present disclosure provide a method for integrated design of compressor blade and casing treatment. The method includes: determining parameterization methods for blade and casing treatment based on a compressor blade model and a casing treatment model, respectively; obtaining an initial parameter set by using a sampling technology, and obtaining a design with wide stability margin by using an advanced optimization algorithm without reducing compressor efficiency.

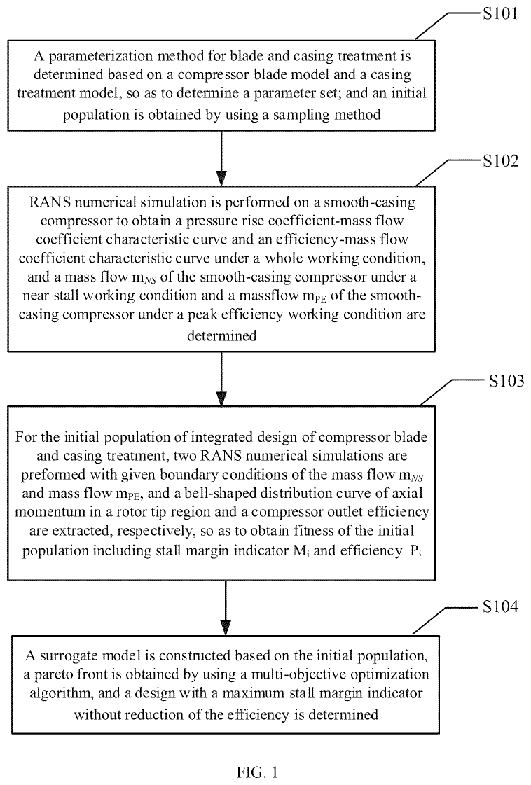

FIG. 1 shows a flowchart of a method for integrated design of compressor blade and casing treatment according to an embodiment of the present disclosure.

As shown in FIG. 1, the method for integrated design of compressor blade and casing treatment may include operations S101 to S104.

In operation S101, a parameterization method and design variables are determined based on initial compressor blade model and casing treatment model, and an initial population is obtained by using an advanced sampling method, where i=1, 2, . . . , N, and N is the number of the initial population.

In operation S102, numerical simulation is performed on a smooth-casing compressor to obtain a pressure rise coefficient-mass flow coefficient characteristic curve and a efficiency-mass flow coefficient characteristic curve under a whole working condition, and a mass flow m_{NS} of the smooth-casing compressor under a near stall working condition and a mass flow M_{PE} of the smooth-casing compressor under a peak efficiency working condition are determined.

In operation S103, for the initial population of integrated design of compressor blade and casing treatment, two RANS numerical simulations are respectively performed with given mass flow boundary conditions of m_{NS} and M_{PE}, and a bell-shaped distribution curve of axial momentum in a rotor tip region, and a compressor outlet efficiency are respectively extracted so as to obtain fitness (including stall margin indicator and efficiency) of the initial population.

In operation S104, a surrogate model is constructed based on the initial population, a multi-objective optimization algorithm is used to obtain a pareto front, and a design with a maximum stall margin indicator is determined without reducing the efficiency.

According to embodiments of the present disclosure, the compressor may include but is not limited to a mixed flow compressor, an oblique flow compressor, a centrifugal compressor, etc.

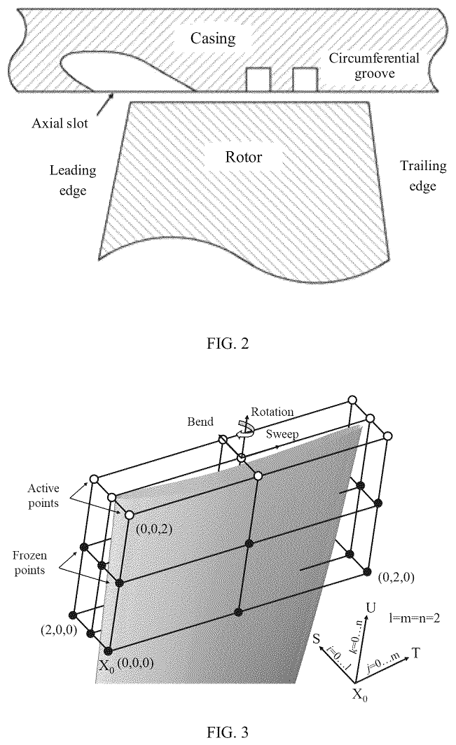

FIG. 2 shows a schematic structural diagram of a compressor blade and casing treatment in a meridian direction according to an embodiment of the present disclosure.

In an exemplary embodiment, an isolated rotor of a typical tip critical low-speed axial flow compressor is selected to evaluate the method for integrated design of blade and casing treatment. The initial compressor blade is an isolated rotor of an axial flow compressor, and its design parameters are shown in Table 1. The initial casing treatment is the slot-groove hybrid casing treatment, and its design parameters are shown in Table 2. An initial axial slot is located at a leading edge of the blade, and an initial circumferential groove is located in the middle of the blade. A schematic diagram of the initial slot-groove hybrid casing treatment in a meridian direction is shown in FIG. 2.

TABLE 1
Design parameters for isolated rotor of compressor

| Parameters | Values | |
|---|---|---|
| Design speed | 2400 | rpm |
| Design mass flow rate | 2.9 | kg/s |
| Number of rotor blades | 60 | |
| Rotor tip chord | 36.3 | mm |
| Tip clearance | 0.8 | mm |

| | |
|---|---|
| Hub-tip ratio | 0.75 |

TABLE 2
Design parameters for slot-groove hybrid casing treatment

| Parameters | Values | |
|---|---|---|
| Slot height | 5 | nm |
| Slot length | 12 | nm |
| Slot inclination | 60° | |
| Groove depth | 3 | mm |
| Groove width | 3 | mm |
| Axial distance between two grooves | 2.5 | mm |

According to embodiments of the present disclosure, a parameterized method for blade and casing treatment is implemented by using free-form deformation technology based on the compressor blade model and the casing treatment model, including the following operations:

A rotor tip region control volume and an axial slot control volume are constructed based on the initial compressor blade model and casing treatment model.

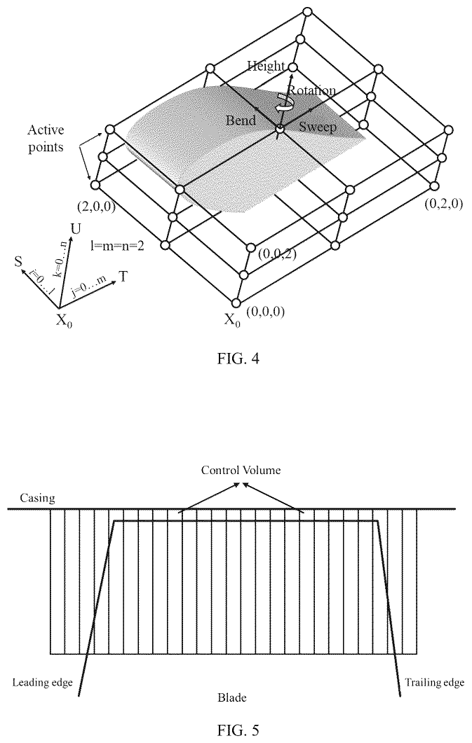

FIG. 3 shows a schematic diagram of a rotor tip region control volume according to an embodiment of the present disclosure. FIG. 4 shows a schematic diagram of an axial slot control volume according to an embodiment of the present disclosure.

The rotor tip region control volume encompasses a blade geometry above 80% of a blade height so as to cover a region affected by a tip leakage flow and a casing treatment circulation flow. The axial slot control volume encompasses an entire axial slot and extends along both radial and circumferential directions, so as to ensure that a freely deformed axial slot may still intersect with a casing wall surface. A rotor tip region parameter set and a casing treatment parameter set are obtained based on deformation constraint conditions. The rotor tip region parameter set includes a blade leading edge bend, a blade trailing edge bend, a blade leading edge sweep, a blade trailing edge sweep, and a blade rotation. The casing treatment parameter set includes an axial slot bend, an axial slot sweep, an axial slot rotation, an axial slot height, and a circumferential groove scaling.

According to embodiments of the present disclosure, the deformation constraint conditions may include that: a variation range of a control point for the blade leading edge bend is −10% to 25% of an axial tip chord length, a variation range of a control point for the blade trailing edge bend is −10% to 25% of the axial blade tip chord length, a variation range of a control point for the blade leading edge sweep is −10% to 25% of the axial blade tip chord length, a variation range of a control point for the blade trailing edge sweep is −10% to 25% of the axial blade tip chord length, a variation range of a control point for the blade rotation is −60° to 60°, a variation range of a control point for the axial slot bend is −15% to 15% of the axial blade tip chord length, a variation range of a control point for the axial slot sweep is −15% to 15% of the axial blade tip chord length, a variation range of a control point for the axial slot rotation is −60° to 60°, a variation range of a control point for the axial slot height is −5% to 20% of the axial blade tip chord length, and a variation range of a control point for the circumferential slot scaling is 4.4% to 17.8% of the axial blade tip chord length.

It should be noted that percentages involved in the above deformation constraint conditions may be set according to actual needs, and the above is only an example to illustrate the embodiment of the present disclosure.

According to embodiments of the present disclosure, free-form deformation (FFD) technology is an important means of editing geometric models. The principle of the free-form deformation is to embed the geometric model into a deformation space, and then manipulate the deformation space to deform the embedded geometric model. The free-form deformation technology may maintain high precision geometric continuity during a deformation process, so that high degree of freedom deformation of the rotor tip region and the axial slot may be achieved with fewer design parameters, and the design space may be expanded.

According to embodiments of the present disclosure, the initial population Ni is obtained by using Latin hypercube sampling technology (LHS), where i=1, 2, . . . , n. LHS is a method of approximating random sampling from parametric multivariate distribution, belonging to a stratified sampling technique.

According to embodiments of the present disclosure, performing RANS numerical simulation on the smooth-casing casing to obtain the mass flow m_{NS} of the smooth-casing compressor under the near stall working condition and the mass flow m_{PE} of the smooth-casing compressor under the peak efficiency condition includes the following operations:

The compressor blade and casing treatment are processed by using grid partitioning technology, where the grid near the casing is encrypted to obtain a full three-dimensional computational grid.

A three-dimensional Reynolds averaged Navier-Stokes equation is calculated and solved by using a turbulence model, so as obtain the pressure rise coefficient-mass flow coefficient characteristic curve and the efficiency-mass flow coefficient characteristic curve under a whole working condition.

According to embodiments of the present disclosure, a grid is generated in a rotor domain by using the grid partitioning technology. A topology structure of the grid may be of an HOH type, and the grid near the wall is encrypted. A grid orthogonality is greater than 30°, and a first layer of the grid is 3 mm away from a casing surface, so as to ensure y+<2, so that calculation requirements of the turbulence model may be met.

According to embodiments of the present disclosure, the turbulence model is used to solve a single-passage three-dimensional Reynolds averaged Navier Stokes equation, where the turbulence model may be a shear-stress-transport turbulence model, with an inlet given a total atmospheric temperature and pressure boundary condition, an outlet given an average static pressure, and the wall given a non-slip boundary condition. An outlet back pressure is gradually increased to obtain the pressure rise coefficient-mass flow coefficient characteristic curve and the efficiency-mass flow coefficient characteristic curve under the whole working condition.

According to embodiments of the present disclosure, the near stall working condition of the smooth-casing compressor is located at the leftmost end of the pressure rise coefficient-mass flow coefficient characteristic curve, and the peak efficiency working condition is located at the top end of the efficiency-mass flow coefficient characteristic curve.

According to embodiments of the present disclosure, for the initial population of integrated design of compressor blade and casing treatment, RANS numerical simulation is performed with a given boundary condition of the mass flow m_{NS}, and the bell-shaped distribution curve of the axial momentum in the rotor tip region is extracted, so as to obtain a first fitness of the initial population, which is the stall margin indicator Mᵢ. RANS numerical simulation is performed with a given boundary condition of the mass flow m_{PE} to extract the compressor outlet efficiency, so as to obtain a second fitness of the initial population, which is the efficiency Pᵢ.

According to embodiments of the present disclosure, the extraction of the stall margin indicator includes the following operations:

Based on discrete conditions, the rotor tip region is divided into discrete control volume, where the discrete conditions include that: the control volume extends 20% of the blade height radially from the inner wall of the casing toward a hub, and the control volume covers the leading edge and trailing edge axially to cover a region affected by the tip leakage flow; the axial momentum passing each discrete control volume is respectively calculated and accumulated along the axial direction to obtain a bell-shaped distribution curve of the axial momentum, where an axial position corresponding to the maximum accumulated axial momentum is the stall margin indicator Mᵢ.

According to embodiments of the present disclosure, m discrete control volumes are constructed in the rotor tip region based on a flow field result calculated using the boundary condition of the mass flow m_{NS}, and the axial momentum of each discrete control volume is calculated and denoted as Rj, where j=1, 2, . . . , m.

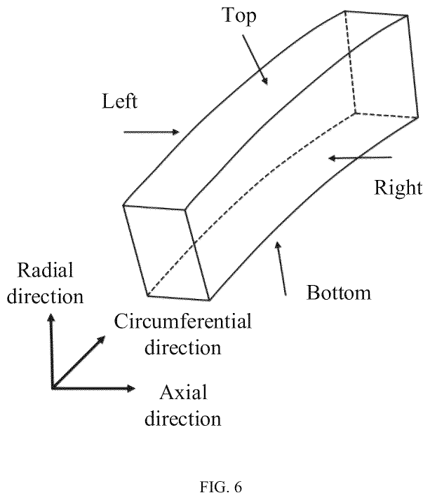

FIG. 5 shows a schematic diagram of a discrete control volume in a meridian direction according to an embodiment of the present disclosure. FIG. 6 shows a three-dimensional schematic diagram of a discrete control volume according to an embodiment of the present disclosure.

According to embodiments of the present disclosure, the discrete control volume extends 20% of the blade height radially from the casing wall to a hub side, covering the region affected by the tip leakage flow; the discrete control volume covers the entire blade tip from the leading edge to the trailing edge in the axial direction; the discrete control volume covers a cascade distance in a circumferential direction, meeting a periodic boundary condition. The schematic diagram of the discrete control volume in a meridian direction is as shown in FIG. 5, and the three-dimensional schematic diagram of the discrete control volume is as shown in FIG. 6.

According to embodiments of the present disclosure, the equation Rj for calculating the axial momentum of the discrete control volume is as shown by formula (1):

Rⱼ=∫_{left}ρV_{z}(\vec{V}·\vec{n})dA_{left}+∫_{right}ρV_{z}(\vec{V}·\vec{n})dA_{right}+∫_{bottom}ρV_{z}(\vec{V}·\vec{n})dA_{bottom}+∫ₜₒₚρV_{z}(\vec{V}·\vec{n})dAₜₒₚ (1)

Here, ρ represents a density of a fluid, A represents an area of a control surface, \vec{V} represents a velocity of the fluid in a relative coordinate system, \vec{n} represents an outer normal vector of the control surface of the control volume, V_{z} represents an axial velocity in the relative coordinate system, ∫_{left}ρV_{z}(\vec{V}·\vec{n})dA_{left} characterizes an axial momentum passing a left side surface of the control volume, ∫_{right}ρV_{z}(\vec{V}·\vec{n})dA_{right} characterizes an axial momentum passing a right side surface of the control volume, ∫_{bottom}ρV_{z}(\vec{V}·\vec{n})dA_{bottom} characterizes an axial momentum passing a bottom surface of the control volume, ∫ₜₒₚρV_{z}(\vec{V}·\vec{n})dAₜₒₚ characterizes an axial momentum passing a casing surface of the control volume.

After obtaining the axial momentum of the discrete control volume, the bell-shaped distribution curve is drawn using the axial position as an abscissa and the accumulated axial momentum of the control volume ahead of the axial position as an ordinate. The axial position corresponding to the maximum accumulated axial momentum is determined as the stall margin indicator M, to measure a stability expansion ability of the optimization solution.

According to embodiments of the present disclosure, the extraction of the efficiency includes the following operation:

the compressor outlet efficiency is extracted directly as the efficiency based on the flow field result calculated using the boundary condition of the mass flow m_{NS}.

According to embodiments of the present disclosure, after obtaining the design parameters and fitness of the initial population, a multi-objective optimization algorithm is used for optimization to determine the design with maximum stability margin expansion and no reduction in efficiency. The optimization algorithm may be an NSGA-II optimization algorithm. The optimization algorithm includes fast non-dominated sorting that may globally search for a non-inferior solution set, and a density estimation function that may analyze a density of the design solution in the design space. A fitness function is predicted by using a Kriging surrogate model, convergence of the optimization is accelerated, and a model accuracy is improved through multiple rounds of point addition during the optimization process.

Embodiments of the present disclosure have been described above. However, these embodiments are only for illustration and are not intended to limit the scope of the present disclosure. Although various embodiments have been described respectively above, this does not mean that measures in the various embodiments may not be advantageously combined. The scope of the present disclosure is limited by the claims and their equivalents. Without departing from the scope of the present disclosure, those skilled in the art may make various substitutions and modifications, all of which shall fall within the scope of the present disclosure.

What is claimed is:

1. A method for integrated design of compressor blade and casing treatment, comprising:
determining a parameterization method for compressor blade and casing treatment and determining a parameter set based on a compressor blade model and a casing treatment model;
obtaining an initial population N, by using a sampling method, where i=1, 2, . . . , N, and N represents a number of the initial population;
obtaining a pressure rise coefficient-mass flow coefficient characteristic curve and an efficiency-mass flow coefficient characteristic curve under a whole working condition by performing a Reynolds-Averaged Navier-Stokes (RANS) numerical simulation on a smooth-casing compressor, and
determining a mass flow m_{NS} of the smooth-casing compressor under a near stall working condition and a mass flow M_{PE} of the smooth-casing compressor under a peak efficiency working condition;
for the initial population of integrated design of compressor blade and casing treatment, extracting a bell-shaped distribution curve of axial momentum in a rotor tip region and a compressor outlet efficiency, respectively, by preforming two RANS numerical simulations with a given boundary condition of the mass flow m_{NS} under the near stall working condition and a given boundary condition of the mass flow M_{PE} under the peak efficiency working condition, so as to obtain fitness of the initial population, wherein the fitness of the initial population includes a stall margin indicator M, and an efficiency Pᵢ; and
constructing a surrogate model based on the initial population, using a multi-objective optimization algorithm to obtain a pareto front, and determining a design with a maximum stall margin indicator without reduction of the efficiency.

2. The method according to claim 1, wherein the parameterization method is a free-form deformation technology, and the parameter set is obtained based on a deformation constraint condition; and
wherein the parameter set comprises a rotor tip region parameter set and a casing treatment parameter set, wherein the rotor tip region parameter set comprises a blade leading edge bend, a blade trailing edge bend, a blade leading edge sweep, a blade trailing edge sweep, and a blade rotation, and the casing treatment parameter set comprises an axial slot bend, an axial slot sweep, an axial slot rotation, an axial slot height, and a circumferential groove scaling.

3. The method according to claim 2, wherein the deformation constraint condition comprises that:
a variation range of a control point for the blade leading edge bend is −10% to 25% of an axial blade tip chord length;
a variation range of a control point for the blade trailing edge bend is −10% to 25% of the axial blade tip chord length;
a variation range of a control point for the blade leading edge sweep is −10% to 25% of the axial blade tip chord length;
a variation range of a control point for the blade trailing edge sweep is −10% to 25% of the axial blade tip chord length;
a variation range of a control point for the blade rotation is −60° to 60°;
a variation range of a control point for the axial slot bend is −15% to 15% of the axial blade tip chord length;
a variation range of a control point for the axial slot sweep is −15% to 15% of the axial blade tip chord length;
a variation range of a control point for the axial slot rotation is −60° to 60°;
a variation range of a control point for the axial slot height is −5% to 20% of the axial blade tip chord length; and
a variation range of a control point for the circumferential slot scaling is 4.4% to 17.8% of the axial blade tip chord length.

4. The method according to claim 1, wherein the sampling method is a Latin hypercube sampling method, and the initial population N, is obtained, where i=1, 2, . . . , N.

5. The method according to claim 1, wherein the RANS numerical simulation comprises:
processing the compressor blade and casing treatment by using a grid partitioning technology, wherein a grid near a wall is encrypted to obtain a full three-dimensional computational grid; and
calculating and solving a three-dimensional RANS equation by using a turbulence model, so as obtain the pressure rise coefficient-mass flow coefficient characteristic curve and the efficiency-mass flow coefficient characteristic curve under the whole working condition.

6. The method according to claim 1, wherein the near stall working condition is located at a leftmost end of the pressure rise coefficient-mass flow coefficient characteristic curve, and the peak efficiency working condition is located at a top end of the efficiency-mass flow coefficient characteristic curve.

7. The method according to claim 1, wherein an extraction of the stall margin indicator M, comprises:
dividing the rotor tip region into discrete control volumes based on a discrete condition, wherein the discrete condition comprises that:
the control volume extends 20% of a blade height from an inner wall of the casing toward a hub in a radial direction; and
the control volume covers a leading edge and a trailing edge in an axial direction to cover a region affected by a tip leakage flow; and
calculating axial momentum of each discrete control volume, respectively, and accumulating the axial momentum along the axial direction so as to obtain the bell-shaped distribution curve of axial momentum, wherein a position corresponding to a maximum accumulated axial momentum in the axial direction is the stall margin indicator Mᵢ.

8. The method according to claim 1, wherein the efficiency Pᵢ is an efficiency corresponding to the peak efficiency working condition.

9. The method according to claim 1, wherein:
the surrogate model is a Kriging surrogate model, and the multi-objective optimization algorithm is an NSGA-II optimization algorithm, including fast non-dominated sorting configured to globally search for a non-inferior solution set and a density estimation function configured to analyze a density of the design solution in a design space; and
a fitness function is predicted by using the Kriging surrogate model.
